(19) United States
(12) Patent Application Publication
(10) Pub. No.: US 2025/0053939 A1
(43) Pub. Date: Feb. 13, 2025

(54) TRANSACTING SYSTEMS AND METHODS FOR NIL COLLECTIVES

(71) Applicant: Stashlete, Inc., Atlanta, GA (US)

(72) Inventor: Melissa Seigler, Atlanta, GA (US)

(21) Appl. No.: 18/446,730

(22) Filed: Aug. 9, 2023

(51) Int. Cl. G06Q 20/10

(52) U.S. Cl. CPC G06Q 20/10

(57) ABSTRACT

Systems and methods for transacting funds to one or more organizations is provided. In some aspects systems and methods can include retrieving a set of transactions for a user, performing, for each transaction in the set of transactions a roundup, generating a total roundup amount for the user, and disbursing the total roundup amount to a set of organizations defined in an allocation distribution scheme.

### FIELD

The technology described herein generally relates to computer implemented systems and methods of digital transacting and/or transaction processing, and more particularly to context-based digital transaction generation, aggregation, and/or distribution for a collective organization.

### BACKGROUND

Recent changes in the rules and regulations relating to the financial support of collegiate-level athletic programs and athletes have led to the proliferation of Name Image Likeness (NIL) collectives, which are structurally independent of a school but provide and fund NIL opportunities for a school's student-athletes. In essence, an NIL collective independent of a school or university can collect donations from individuals and/or businesses to facilitate NIL opportunities or deals and further enable other avenues for student-athletes to capitalize and build on their brands.

An NIL collective is typically driven by boosters, such as individuals or businesses, who can donate to a collective through one-time payments or subscriptions, for example. Generally, NIL collectives are set up as marketplace collectives and/or donor-driven collectives, with the latter being set up to pool together supporter funds to then create opportunities for athletes to give the money back to them. However, as independent third-party organizations operating outside of the university system, NIL collectives themselves manage the pooled money and determine which programs and/or athletes receive funds.

Accordingly, there is a need to enable a more efficient and targeted platform for the collection and distribution of funds particularly in the context of NIL collectives. The technology described herein provides systems and methods that allows for aggregating a set of transactions for a user, implementing a roundup scheme based on the set of transactions to, in essence, generate a new transaction, and distributing funds received based on the new transaction to one or more organizations based on an allocation scheme configured by the user.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

At a high level, embodiments of the technology described herein are generally directed towards aggregating a set of transactions for a user, rounding up each transaction in the set of transactions and generating a sum of roundups up to a predetermined maximum round up amount, generating a transaction for the user based on the sum of roundups and disbursing the generated transaction to one or more organizations based on a user allocation scheme.

According to some embodiments, a system for transacting funds to an organization is provided. The system can comprise, among other components, a transaction engine, configured to retrieve a set of transactions associated with a user, a roundup engine, wherein the roundup engine performs a series of roundups on the set of transactions and generates sum totals for each organization in a set of organizations defined by the user, and a distribution engine, wherein the distribution engine distributes funds to each organization based on the sum totals for each organization

According to some further embodiments, a computer-implemented method for transacting funds to one or more organizations is provided. In some aspects the method can include retrieving a set of transactions for a user, performing, for each transaction in the set of transactions, a roundup, generating a total roundup amount for the user, and disbursing the total roundup amount to a set of organizations based on an allocation distribution associated with the user.

Additional objects, advantages, and novel features of the technology will be set forth in part in the description that follows, and in part will become apparent to those skilled in the art upon examination of the following, or can be learned by practice of the invention.

### BRIEF DESCRIPTION OF THE DRAWINGS

Aspects of the present disclosure can be better understood with reference to the following drawings. The components in the drawings are not necessarily to scale, with emphasis instead being placed upon clearly illustrating the principles of the disclosure. Aspects of the technology presented herein are described in detail below with reference to the accompanying drawing figures, wherein:

FIG. 1 shows a schematic illustrating an example operating environment of a collective transaction system, in accordance with some aspects of the technology described herein;

FIG. 2 illustrates an example collective transaction system, in accordance with some aspects of the technology described herein;

FIG. 3A1 illustrates an example flow diagram showing various aspects of a collective transaction system, in accordance with some aspects of the technology described herein;

FIG. 3A2 illustrates an example flow diagram showing various aspects of a collective transaction system, in accordance with some aspects of the technology described herein;

FIG. 3A3 illustrates an example flow diagram showing various aspects of a collective transaction system, in accordance with some aspects of the technology described herein;

FIG. 3B illustrates an example flow diagram showing various aspects of a collective transaction system, in accordance with some aspects of the technology described herein;

FIG. 4 illustrates an example flow diagram showing various aspects of a collective transaction system, in accordance with some aspects of the technology described herein;

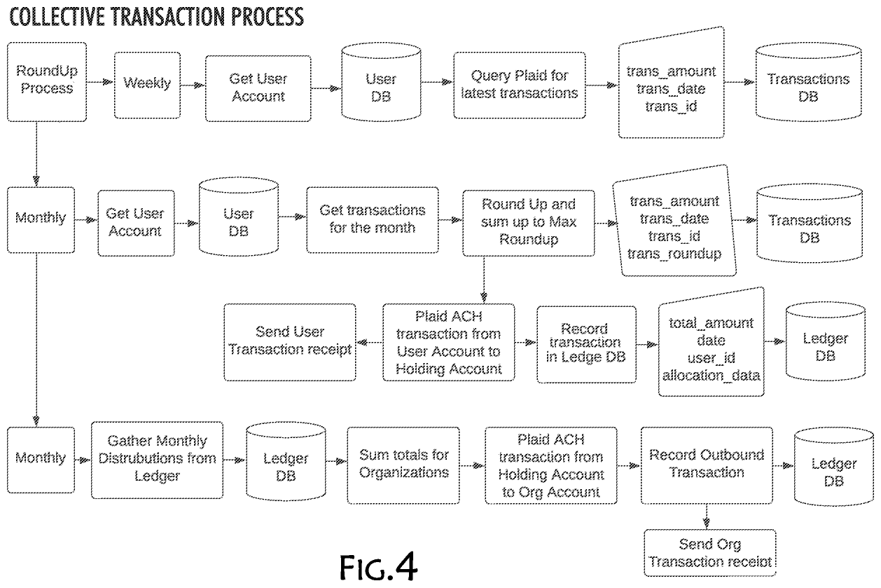

FIG. 5 shows an example data structure for a collective transaction system accordance with some aspects of the technology described herein;

FIG. 6A is a schematic illustrating example allocation and distribution aspects of a collective transaction system, in accordance with some aspects of the technology described herein;

FIG. 6B is an example graphic user interface illustrating example allocation and distribution aspects of a collective transaction system, in accordance with some aspects of the technology described herein; and

FIG. 7 is a block diagram of an example computing environment and/or device architecture in which some implementations of the present technology may be employed.

### DETAILED DESCRIPTION

The subject matter of aspects of the present disclosure is described with specificity herein to meet statutory requirements. However, the description itself is not intended to limit the scope of this patent. Rather, the inventor(s) have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Described herein are transacting systems and methods, more specifically, transaction systems and methods for the collection and distribution of funds, for instance in the NIL collective space. In some instances, transaction (or transacting) systems and methods (also referred to herein as a collective transaction system) can be employed as context-based systems and/or applications, for example where funds can be collected and/or distributed based on a context provided by or associated with one or more users.

The present technology may be embodied as, among other things, a system, method, or computer-product. Accordingly, embodiments may take the form of a hardware embodiment, a software embodiment, or an embodiment combining software and hardware. In one embodiment, the present invention takes the form of a computer program product that includes computer usable instructions embodied on one or more computer readable media and executed by one or more processors.

Computer readable media includes both volatile and nonvolatile media, removable and non-removable media, and media readable by a database, a switch, and various other network devices. Network switches, routers, access points, and related components in some instances act as a means of communication within the scope of the technology. By way of example, computer readable media comprise computer storage media and communications media.

Computer storage media or machine readable media can include media implemented in any method or technology for storing and/or transmitting information or data. Examples of such information include computer-usable instructions, data elements, data structures, programs and program modules, and other data representations.

Communications media generally store computer usable or readable instructions, including data structures and program modules in a modulated data signal. A modulated data signal in some instances can be understood to be a propagated signal that has one or more of its characteristics set or changed to encode information in the signal. Communications media include any information-delivery media. By way of example and not limitation, communications media include wired media, such as a wired network or direct-wired connection, and wireless media such as radio, cellular, spread-spectrum, and other wireless media technologies. Combinations of the above are included with the scope of computer readable media and communications media.

According to some aspects, systems and methods for the collection and distribution of funds and/or data are provided, for instance to one or more organizations and/or to one or more units within the one or more organizations. As will be appreciated, organizations as used with respect to the present technology can be configured as parent organizations with child organizations, also referred to as units, associated therewith. As such, a first organization can have one or more associated or corresponding units, a second organization can have one or more corresponding units, and so on.

In some aspects, systems and methods can be implemented to handle or otherwise carry out and manage digital data and/or fund collection, manipulation, transfer, and/or distribution. In some instances, aspects of the systems and methods described herein can be carried out as one or more discrete tasks or configured to be implemented in a continuous process.

In some instances, transaction (or transacting) systems and methods or collective transacting systems can be employed as context-based systems and/or applications, for example where funds can be collected and/or distributed based on a context provided by or associated with one or more users. Accordingly, in some aspects, a user can configure a profile to drive or control various aspects of a transacting system. For example, a context based on a user profile can include a minimum and/or maximum weekly/monthly/yearly amount to be transacted or distributed. Additionally, a user profile can designate one or more organizations for distribution and optionally organization units or subunits for distribution. A user can also configure percentages and/or amounts for each organization or organizational unit for funds to be distributed based on. In one example, on a monthly basis, a set of transactions for a user can be pulled, and for each transaction a roundup can be performed up to a set max roundup value, which may be predetermined by a user as a part of a user profile. As will be appreciated, a roundup (or roundup amount) can be based on a single transaction where a fractional value is rounded up to the next nearest whole value. In some aspects the roundup can also be referred to as a delta value for each transaction. In some further aspects, each roundup or delta value can be summed up to a max roundup value. As will be appreciated the roundup process can be iterative amongst a set of transactions and the roundup process can stop once a predetermined max roundup value is reached, for instance, for the given time period (e.g. week, month, year).

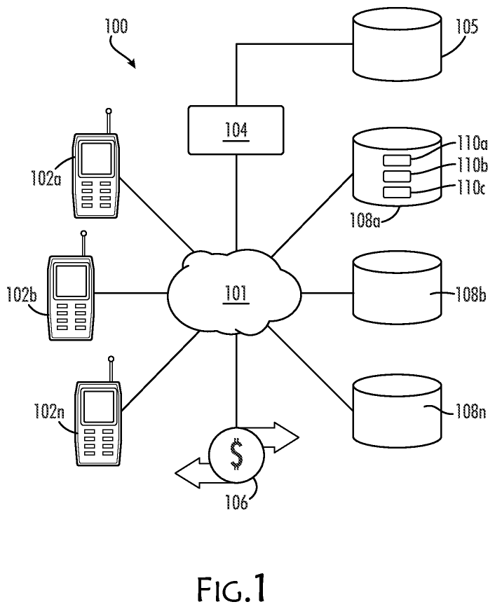

Referring now to the drawings, and initially to FIG. 1, an example collective transaction system 100 is depicted in accordance with various embodiments of the present technology. As will be appreciated, collective transaction system 100 is depicted as an example operating environment showing various aspects of a system and the implementation thereof. Collective transaction system 100 can include one or more user devices 102a, 102b, 102n, for example any suitable computing device for running an application, such as a computer, tablet, or smart phone, in communication with a network 101. As will be appreciated, a user device 102a, 102b, 102n can be connected to network 101 via one or more access points (i.e. network access points) that may be implemented as, for example, a router, base station microcell, and/or macrocell, and configured to detect signals from user devices 102a, 102b, 102n and transmit one or more signals over the network 101. A user device 102a, 102b, 102n can be further configured to run one or more applications and/or programs. Collective transaction system 100 can further include collective transaction application 104 which can be configured to run on a user device (102a, 102b, 102n), be hosted on one or more servers (e.g. server 105) or configured as a distributed application. Among other components not shown, collective transaction application 104 may include at least one of a collection component and/or a distribution component. Collective transaction application can be in operative communication with one or more servers 105 or a data store or database, for example a user database, a transaction database, and/or a ledger database.

Collective transaction system 100 (also referred to as collective system) can further include one or more participating organizations (also referred to herein as collectives or organizations) 108a, 108b, 108n which can be in communication with collective transaction system 100 and/or collective transaction application 104 via network 101. Each organization 108a, 108b, 108n can further comprise one or more unique units, for example organization units or subunits 108a, 108b, 108n. In some further instances, collective transaction system can implement or otherwise be connected in part by a transaction network, application, or service 106 that can be configured to enable collective transaction application 104 to connect with a user's bank account (with any relevant permissions) to power digital transaction services (e.g. digital finance services) which can be implemented to enable the transfer of funds from a user's bank account to an organization (or more particularly to an organization unit) via the collective transaction application 104 which can process transactions based on a context (e.g. a user generated profile) and/or utilizing one or more ledgers comprising relevant stored data and/or data elements.

Collective transaction system 100 can further be implemented as a LAN, WAN, or cloud-based setup. Data store 105 can ingest and/or store data received from user devices 102a, 102b, 102n (e.g. a plurality of data elements) which can be collected by collective transaction application 104 (running locally, remotely, or on the cloud). Data received and/ingested (e.g. by a pull and/or push function) by data store 105 can be stored in any format, which can include structured, semi-structured, and unstructured data objects. Data stored in data store 105 can be further processed or otherwise transformed and stored. As will be appreciated, data store 105 can be implemented as a partitioned data store, one or more data stores, or one or more cloud based data stores. Although not depicted, stored data can further be enriched by blending the data with other data sets from other sources. In some aspects, collective transaction application can query or mine data store 105 for relevant data elements corresponding to a user or user device 102a, 102b, 102n and/or input and/or transactional data acquired by user devices 102a, 102b, 102n, (e.g. via an application interface), or network data

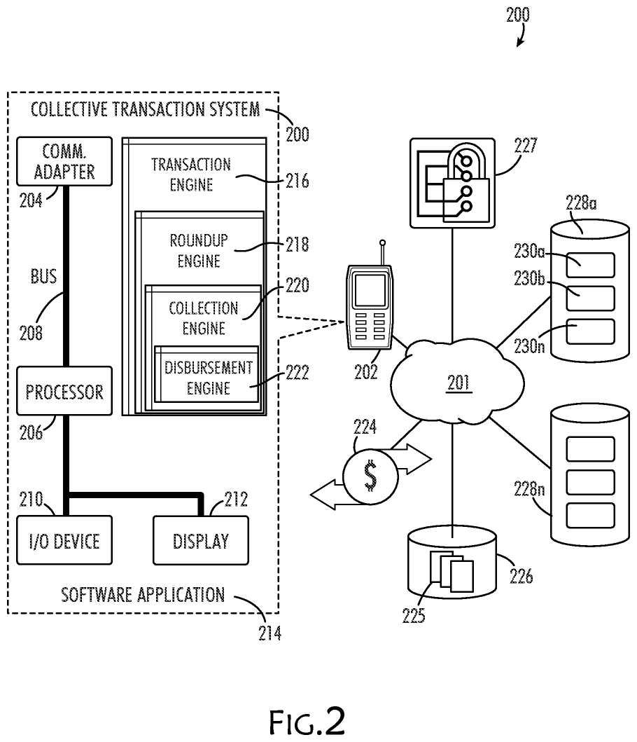

Turning now to FIG. 2, a block diagram of an example collective transaction system or application 200 is shown, in accordance with some aspects of the present technology. As will be appreciated, collective transaction system 200 as depicted is a conceptual diagram and is not meant to show all network and system components and boundaries. It should be understood that this and other arrangements described herein are set forth as examples. Other arrangements and elements (e.g. machines, interfaces, functions, orders, and groupings of functions) can be used in addition to or instead of those shown, and some elements or components are omitted for the sake of clarity. Further, many of the elements and components described herein are functional entities that can be implemented as discrete or distributed components and/or functions or in conjunction with other components, and in any suitable combination and location. Various functions described herein as being performed by one or more entities can be carried out by hardware, firmware, and/or software. For instance, some functions can be carried out by a processor executing instructions stored in memory.

In the example illustrated by FIG. 2, a user device or computing device 202 200 is configured with a software application 214 (e.g. collective transaction application), wherein the software application is executed by a processor 206 that stores the contents of executable code within memory. In this way one or more engines and/or modules, 216, 218, 220, and/or 220 for example, are stored on the memory of the computing device and is translated and executed at the processor 206, wherein the instructions travel along the bus from the memory and back to the processor. When a user interacts with the computing system 202 and application, through an I/O device or interface, the user transmits signals to the processor in respect to prompts or other features. In the case of a collective transaction system 200, a user can create a user account and further, a user profile which can in some instances provide a context for the user to the application and/or system to drive the collection and distribution of funds to one or more organizations (228a, 228n) and/or organization units (230a, 230b, 230n). As will be appreciated, a user device 202 can be connected to network 201 which may further incorporate one or more organizations (228a, 228n), financial transaction service 224 configured to charge and/or transfer funds from a user device to one or more organizations 228a, 228n using one or more data sets 225 (e.g. ledgers, data elements, user profiles, etc.) stored on a database 225, which may be configured as one or more data stores. In some aspects data store 226 may include user information such as user profiles which may be stored as a user data set or context set 225. Collective transaction system 200 can further incorporate one or more holding accounts 227 which can be implemented to temporarily hold funds received or pulled from a user device and/or user account (e.g. a user's linked bank account, credit card, etc.).

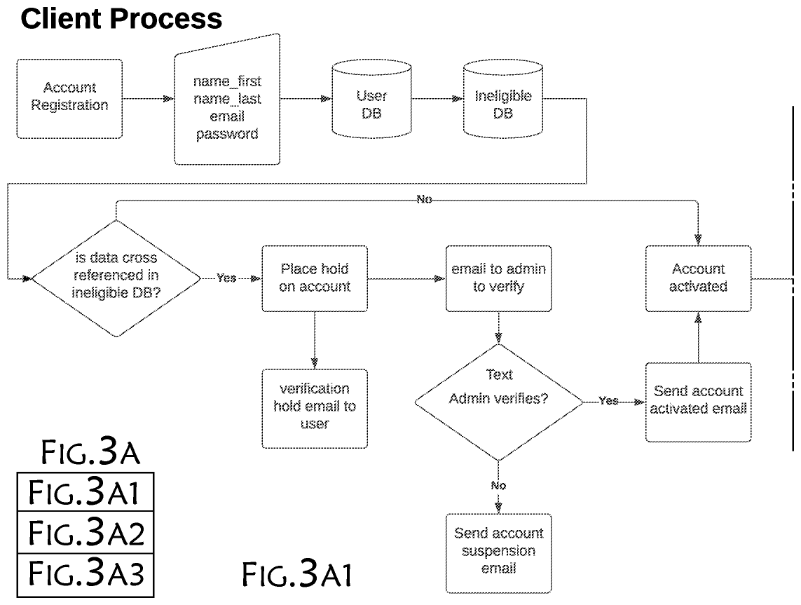

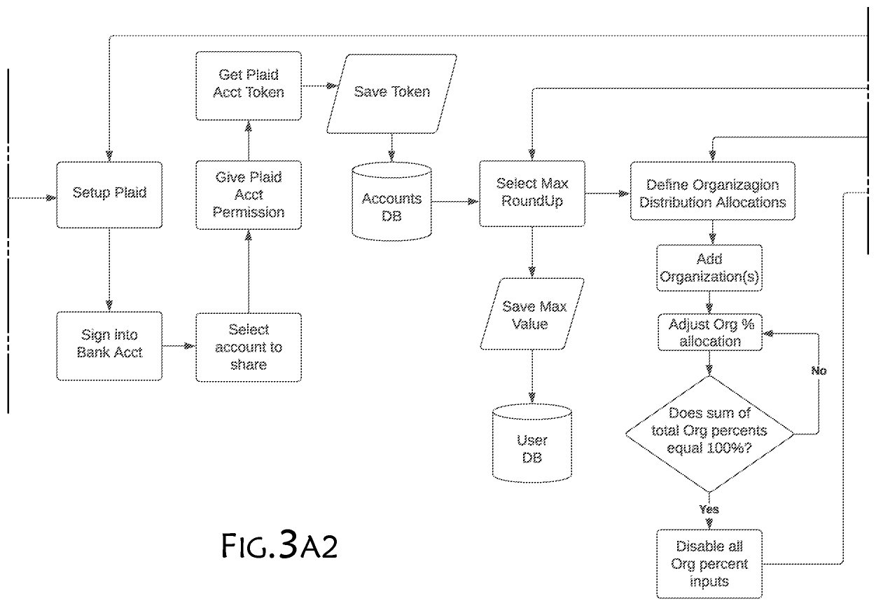

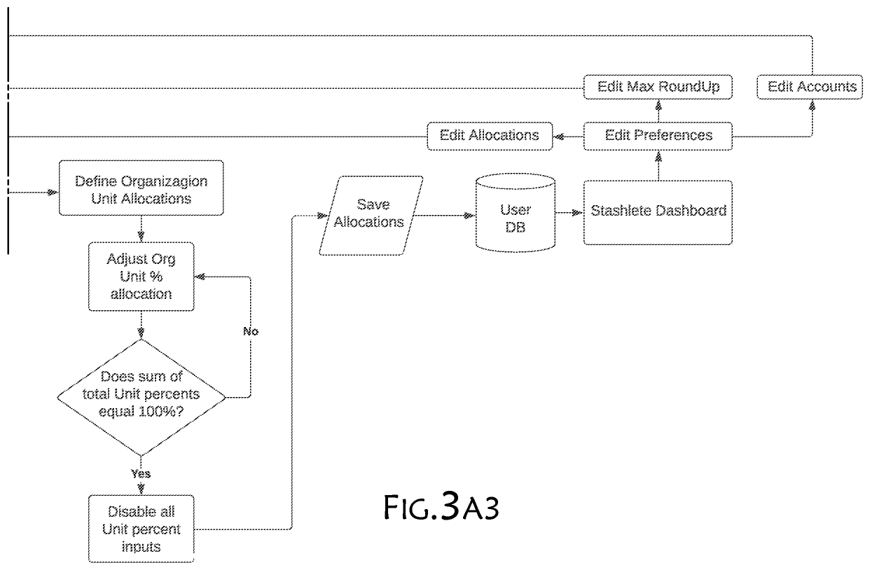

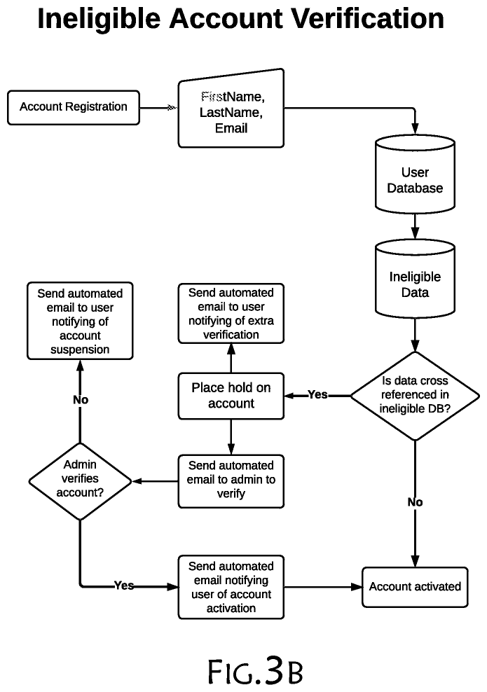

Continuing, with reference to FIG. 3, collective transaction system 200 can include one or more engines or modules, such as a transaction engine 216, roundup engine 218, collection engine 220, and/or disbursement engine 222. As will be appreciated these engines are exemplary and not intended to limit collective transaction system and/or application 200 but to highlight various aspects of the technology. In some instances, a transaction engine 216 can on some predetermined interval (e.g. daily, weekly, monthly) query a user database for a user's account as well as associated information about the user and/or the account, for instance user preferences or inputs, or further any changes or deltas in a user's account or related information that has changed since a previous query. Based on associated data with a user's account, transaction engine 216 can query financial transaction service 224 (e.g. Plaid or an application built thereon) for the most recent bank transactions associated with a user (e.g. debit card transactions, credit card transactions) and can determine or pull information relating to one or more transactions (e.g. transaction amount, transaction date, transaction id) and store those transaction within the collective transaction system (e.g. in a transactions database or dataset). Accordingly, collective transaction system 200 can store a lean set of user transactions, for instance for a given month. In some instances, collective transaction system can be configured to pull only new transactions since the last query or data pull.

Subsequently, in some instances, roundup engine 218 can, on some predetermined interval (e.g. monthly, bi-monthly), retrieve a user account from a database (e.g. user database) as well as a set of transactions (e.g. transactions for the month stored in a transactions database) and perform a set of roundups on the transactions. For example, a user purchases some goods or services with a credit card, bank card, debit card, etc., and for each purchase (i.e. transaction), the collective transaction system can round each transaction up, and keep a running cumulative sum of the collective roundups. In some aspects, roundup engine 218 can perform roundups on a set of transactions and keep a cumulative sum up to a maximum roundup total, which may be defined by a user. A roundup total can be stored along with other transaction data, (e.g. transaction amount, transaction date, transaction id) within the collective transaction system (e.g. in a transactions database or dataset).

Subsequently, collection engine 220 can, on some predetermined interval (e.g. monthly) query one or more databases in the system (e.g. user database, transaction database) to determine the roundup total for a user for the given time period, and utilizing the financial transaction service 224 generate a payment from a user into a holding account 227 which is associated with the collective transaction system 200. Once a transaction is processed from the user into the holding account 227 the transaction can be recorded in a ledger database, for example, and a transaction receipt can be sent to the user. In some aspects, a line item of a recorded transaction in a ledger database can include a date, a total amount (e.g. corresponding to the roundup total), the associated user identifier, and allocation data associated with the user, which can be retrieved from a user database.

Additionally, on some predetermined interval (e.g. monthly) a disbursement engine 222 can be employed to transfer funds from holding account 227 to one or more organizations 228a, 228b. Monthly distributions can be retrieved from a ledger database, totals can be summed for each organization, and the system can utilize a financial transaction service 224 to provide an automated clearing house transaction from holding account 227 to one or more accounts associated with one or more organizations 228a, 228n. The outbound transactions can be stored in a database associated with the system, such as a ledger database. Additionally, a transaction receipt may be sent to each organization to which funds were transferred. In some instances, a transaction receipt can be sent with a distribution ledger to each organization. In some other instances, a set of instructions may be sent with the transaction receipt to automate the distribution on the organization side, for example the instructions can be carried out by another system to automate the distribution to any number of units within an organization.

Turning briefly to FIGS. 3A and 3B, example dataflows for setting up a user account and verifying accounts is provided. As will be appreciated, these processes are illustrative, and other methods may be employed. As illustrated, the dataflows incorporate the configuration or definition of user profiles, which can be incporated into systems described herein to provide context-based transacting systems. The profiles (or user context) can be utilized for the collection and more specifically the distribution of funds to one or more organizations and organization subunits. In some aspects a user profile or context an be referenced during a roundup process (e.g. through the roundup engine), collection process (e.g. through the collection engine), or the disbursement and/or distribution process (e.g. through the disbursement engine).

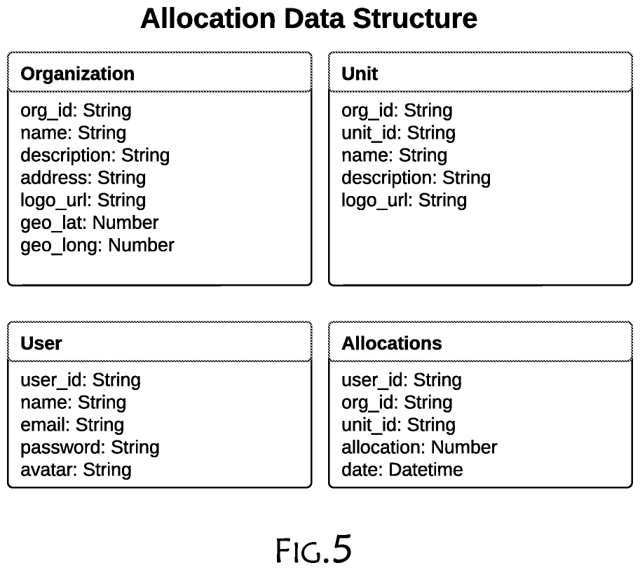

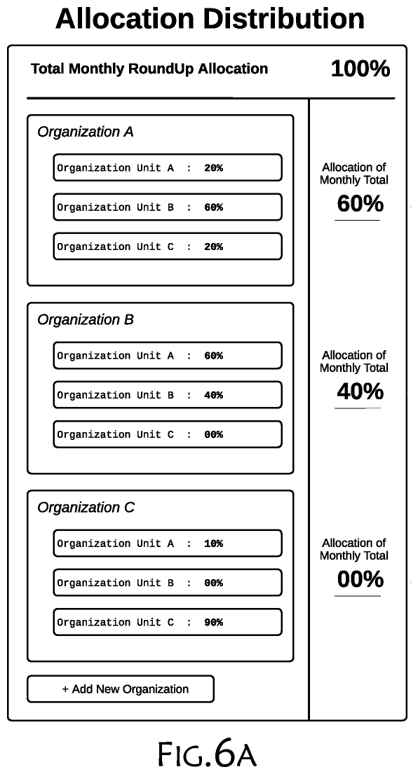

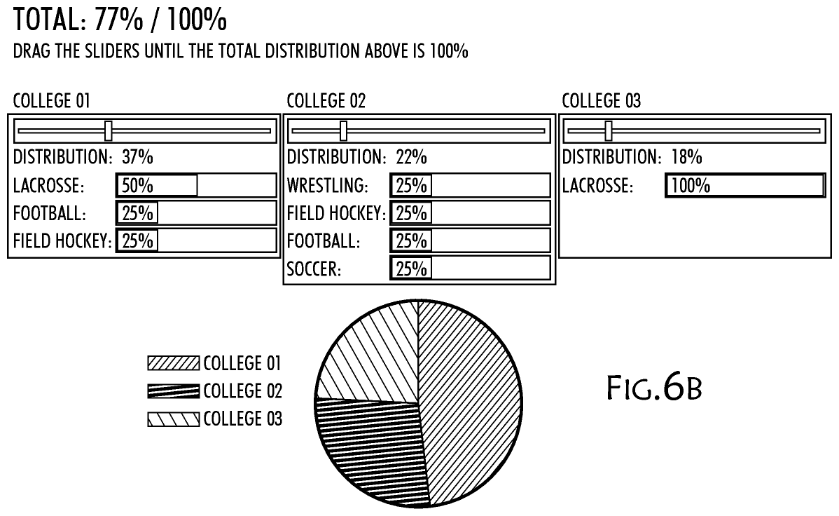

Turning briefly to FIG. 5, example data elements monitored and/or captured in the edge network monitoring and adaptation system described herein are illustrated, in accordance with some aspects of the technology described herein. As will be appreciated, FIG. 5 illustrates example data elements monitored and/or collected or otherwise captured by the system, or one or more devices within the system, and subsequently stored as part of one or more user databases or ledgers. As will be appreciated, data elements illustrated in FIG. 5 generally relate to allocation data configured by a user. Referring to FIG. 6A an example allocation distribution for a user is illustrated which can be utilized by the system to determine how to distribute funds (e.g. roundup funds) from a user to an organization or further with respect to units within an organization. FIG. 6B illustrates an example GUI that a user can interact with to configure an allocation distribution.

Having described various aspects of transacting systems for collective organizations, example methods are now described for implementing the forgoing systems. Methods described herein can be carried out by user action, computing processes, digital conversion processes, or a combination comprising the foregoing. In some instances, methods described herein comprise a computing process that can be performed using any combination of hardware, firmware, and/or software. For instance, a processor executing instructions stored in memory can carry out various functions. The methods can also be embodied as computer-usable instructions stored on computer storage media. The methods can be provided by a standalone application, a service or hosted service (standalone or in combination with another hosted service), or a plug-in to another product, to name a few.

At a first block, a set of transactions for a use can be retrieved and stored in a transactions database, which can in some instances can be carried out on some predetermined interval (e.g. weekly). In some cases, the system can utilize a financial transaction service or network to query a user's connected financial institution for a set of new transactions since a last data pull. At a second block, a set of transactions for a given time period (e.g. a month) are queried and/or pulled by the system, and a series of roundups are determined and/or performed for each transaction in the set of transactions. The individual roundups may be summed (i.e. as a cumulative sum for the set of transactions), and further the roundups can be carried out until a maximum roundup amount is reached. The maximum roundup amount can be set by the user and associated with a user profile. At a third block, the user is charged the maximum roundup amount, or alternatively total roundup amount, or alternatively a minimum amount set by the system, the amount is stored in a holding account. The transaction is recorded by the system and stored in association with an allocation distribution configured by the user. At a fourth block, a series of distributions is gathered and sum totals for a series of organizations is performed. A set of transactions is subsequently generated to distribute funds from the holding account to the set of organizations based on one or more allocation distributions.

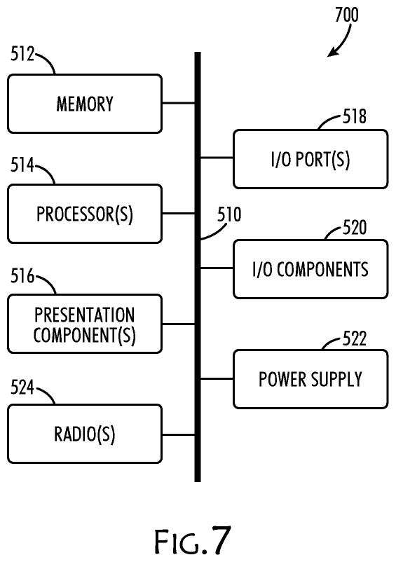

FIG. 7 provides an illustrative operating environment for implementing embodiments of the present invention and designated generally as computing device 700. Computing device 700 is merely one example of a suitable computing environment and is not intended to suggest any limitation as to the scope of use or functionality of the invention. Neither should the computing device 700 be interpreted as having any dependency or requirement relating to any one or combination of components illustrated.

Embodiments of the invention can be described in the general context of computer code or machine-usable instructions, including computer-executable instructions such as program modules, being executed by a computer or other machine (virtual or otherwise), such as a smartphone or other handheld device. Generally, program modules, or engines, including routines, programs, objects, components, data structures etc., refer to code that perform particular tasks or implement particular abstract data types. Embodiments of the invention can be practiced in a variety of system configurations, including hand-held devices, consumer electronics, general-purpose computers, more specialized computing devices, etc. Embodiments of the invention can also be practiced in distributed computing environments where tasks are performed by remote processing devices that are linked through a communications network.

With reference to FIG. 7, computing device 700 includes a bus 710 that directly or indirectly couples the following devices: memory 712, one or more processors 714, one or more presentation components 716, input/output ports 718, input/output components 720, and an illustrative power supply 722. In some embodiments, devices described herein utilize wired and rechargeable batteries and power supplies. Bus 710 represents what can be one or more buses (such as an address bus, data bus or combination thereof). Although the various blocks of FIG. 7 are shown with clearly delineated lines for the sake of clarity, in reality, such delineations are not so clear and these lines can overlap. For example, one can consider a presentation component such as a display device to be an I/O component as well. Also, processors generally have memory in the form of cache. It is recognized that such is the nature of the art, and reiterate that the diagram of FIG. 7 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 7 and reference to “computing device” or “user device.”

Computing device 700 typically includes a variety of computer-readable media. Computer-readable media can be any available media that can be accessed by computing device 700, and includes both volatile and non-volatile media, removable and non-removable media. By way of example, and not limitation, computer-readable media can comprise computer storage media and communication media.

Computer storage media include volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner at to encode information in the signal. By way of example, and not limitation, communication media includes wired media such as a wired network or direct-wired connection, and wireless media such as acoustic, RF, infrared, NFC, Bluetooth, cellular, and other wireless media. Combinations of any of the above should also be included within the scope of computer-readable media.

Memory 712 includes computer storage media in the form of volatile and/or non-volatile memory. As depicted, memory 712 includes instructions 724, when executed by processor(s) 714 are configured to cause the computing device to perform any of the operations described herein, in reference to the above discussed figures, or to implement any program modules described herein. The memory can be removable, non-removable, or a combination thereof. Illustrative hardware devices include solid-state memory, hard drives, optical-disc drives, etc. Computing device 700 includes one or more processors that read data from various entities such as memory 712 or I/O components 720. Presentation component(s) 716 present data indications to a user or other device. Illustrative presentation components include a display device, speaker, printing component, vibrating component, etc.

I/O ports 718 allow computing device 700 to be logically coupled to other devices including I/O components 720, some of which can be built in. Illustrative components include a microphone, joystick, touch screen, presentation component, satellite dish, scanner, printer, wireless device, battery, etc.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and sub combinations are of utility and can be employed without reference to other features and sub combinations and are contemplated within the scope of the claims.

1. A system for transacting funds to an organization, the system comprising:
a computing device, equipped with a user input device and a display device; and
a software application held on memory of the computing device, the software application comprising:
a transaction engine, configured to retrieve a set of transactions associated with a user;
a roundup engine, wherein the roundup engine performs a series of roundups on the set of transactions and generates sum totals for each organization in a set of organizations defined by the user; and
a distribution engine, wherein the distribution engine distributes funds to each organization based on the sum totals for each organization.

2. The system of claim 1, wherein the distribution engine distributes funds based on an allocation distribution.

3. The system of claim 2, wherein the allocation distribution comprises a max roundup amount.

4. The system of claim 2, wherein the allocation distribution comprises a set of organizations and a set of organization units corresponding to each organization.

5. The system of claim 1, further comprising a collection engine configured to charge an amount corresponding to a total roundup amount to a user.

6. A computer-implemented method for transacting funds to organizations, the method comprising:
retrieving a set of transactions for a user;
performing, for each transaction in the set of transactions, a roundup;
generating a total roundup amount for the user;
charging the user the total roundup amount and storing the total roundup amount in a holding account; and
disbursing the total roundup amount to a set of organizations based on an allocation distribution associated with the user.

7. The method of claim 6, wherein the generating a total roundup amount for a user further comprises determining a maximum roundup amount.

8. The method of claim 6, wherein the generating a total roundup amount for a user further comprises generating a cumulative sum roundup transactions.

9. The method of claim 6, further comprising gathering a set of monthly distributions and determining a total for each organization in the set of organizations.

10. The method of claim 6, further comprising performing a transaction from the holding account to an account associated with an organization, wherein the transaction comprises sending an associated allocation distribution.
